(19) United States
(12) Patent Application Publication
(10) Pub. No.: US 2026/0057251 A1
(43) Pub. Date: Feb. 26, 2026

(54) SPATIALLY PIPELINED BINARY SEARCH IN SORTED ARRAYS

(71) Applicant: XILINX, INC., San Jose, CA (US)

(72) Inventor: Thomas Bernd PREUSSER, Dresden (DE)

(21) Appl. No.: 18/815,695

(22) Filed: Aug. 26, 2024

(51) Int. Cl. G06N 5/01

(52) U.S. Cl. CPC G06N 5/01

(57) ABSTRACT

Embodiments herein describe techniques for spatially unrolling thresholds (e.g., steps) for traversing a binary search tree. A binary search tree permits quantization logic to quickly search through thresholds stored in memory to perform quantization (e.g., convert an input value into one of the thresholds). Assuming the thresholds are sorted in order when stored in memory, the result of comparing the input value to a threshold in the current level of the binary tree can be used to select the address of the next threshold in the next level of the binary tree. This permits the quantization logic to traverse the thresholds in a logarithmic manner.

### TECHNICAL FIELD

The embodiments presented herein relate to spatial unrolling of the steps performed by a binary search of a key value within a sorted array.

### BACKGROUND

Neural networks (NNs) are known for their large computational and memory requirements. Quantization of weights and activations to integers is commonly applied to decrease this cost, while keeping tensor- or channel-wise scaling factors in floating point to obtain higher accuracy.

Monotonic quantized activations with floating-point scale factors can be implemented using multi-thresholding operations in hardware. This avoids expensive floating-point arithmetic while preserving the accuracy benefits. However, this comes at a memory storage cost for threshold values that grows exponentially with the bit-width of the quantized activations.

### SUMMARY

One embodiment described herein is computing system that includes circuitry that includes quantization logic implementing a binary search tree traversal, the quantization logic configured to compare an input to a median threshold corresponding to a root node of the binary search tree; select, using an output of the comparison, an address of a second threshold in a second level of the binary search tree; compare the input to the second threshold; and select, using outputs of both comparisons, an address of a third threshold in a third level of the binary search tree.

One embodiment described herein is a method that includes comparing an input to a median threshold corresponding to a root node of a binary search tree; selecting, using an output of the comparison, an address of a second threshold in a second level of the binary search tree; comparing the input to the second threshold; and performing quantization of the input based on outputs of both comparisons.

One embodiment described herein is a binary search tree that includes a first comparator configured to compare an input to a median threshold corresponding to a root node of the binary search tree; circuitry configured to select, using an output of the first comparator, an address of a second threshold in a second level of the binary search tree; a second comparator configured to compare the input to the second threshold; and circuitry configured to select, using outputs of both the first and second comparators, an address of a third threshold in a third level of the binary search tree.

### BRIEF DESCRIPTION OF DRAWINGS

FIG. 1 illustrates a system for performing quantization using linear thresholds, according to one embodiment herein.

FIG. 2 illustrates a system for performing quantization using linear thresholds, according to one embodiment herein.

FIG. 3 illustrates a system for performing quantization using linear thresholds, according to one embodiment herein.

FIG. 4 illustrates a system for performing quantization using non-linear thresholds, according to one embodiment herein.

FIG. 5 illustrates quantization logic implemented using a binary search tree, according to one embodiment herein.

FIG. 6 is a flowchart for performing multi-thresholding using a binary search tree, according to an example.

FIG. 7 illustrates per-channel quantization logic implemented using a binary search tree, according to an example.

FIG. 8 is a block diagram of a computing system, according to an example

### DETAILED DESCRIPTION

The embodiments herein describe techniques for spatially unrolling the thresholding operation (e.g., steps) using a binary search tree. These techniques can be used, for example, to perform quantization for any number of activation functions such as rectified linear unit (ReLU), tanh, sigmoid, and the like so long as the overall resultant operation is monotonic. While the embodiments herein can be used for linear functions (like ReLU), they may be especially advantageous to use with non-linear activation functions (like tanh and sigmoid). In those functions, the quantization thresholds can different widely, which often means they are stored in memory, while linear thresholds can be calculated on the fly without being stored in memory.

A binary search tree permits quantization logic to quickly search through thresholds stored in memory to perform quantization (i.e., to position an input value with respect to the elements of an ordered list of thresholds). Assuming the thresholds are sorted in order when stored in memory, the result of comparing the input value to a threshold in the current level of the binary tree can be used to select the address of the next threshold in the next level of the binary tree. This permits the quantization logic to traverse the thresholds in a logarithmic number of steps. This can greatly improve performance relative to a technique that compares the input to each threshold sequentially. Conversely, it avoids the compute resource explosion of implementing all threshold comparisons in parallel while achieving the same throughput when implemented in pipelined fashion.

Moreover, the addressing technique described herein can be extended to a per-channel quantization scheme (or to any other desired granularity). For this purpose, a channel address prefix can be used to partition the set of thresholds on a per-channel basis so that the input can be compared to the thresholds determined for a particular channel.

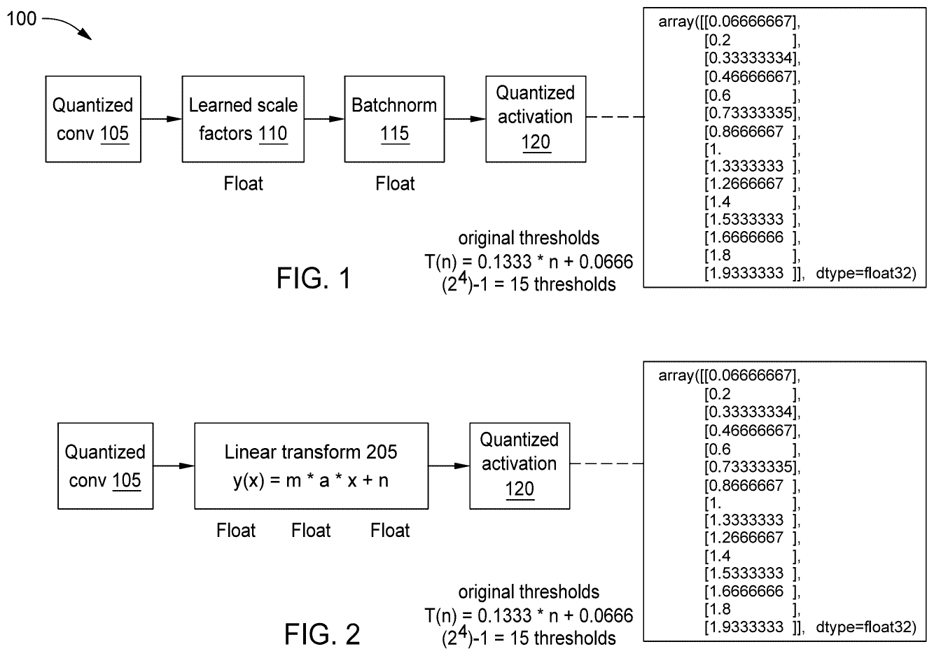

FIG. 1 illustrates a system 100 for performing quantization using linear thresholds, according to one embodiment herein. In one embodiment, the system 100 is part of a NN. However, the embodiments herein are not limited to a NN and may be used in any artificial intelligence, machine learning or traditional application which performs quantization.

In FIG. 1, there are two layers of per-channel floating-point scaling factors: the scaling factors 110 learned for the convolutional layer weights of the quantized convolution (conv) layer 106, followed by the scaling introduced by a batch normalization (batchnorm) layer 115. The batchnorm layer 115 may also include an additive bias corresponding to a zero-point for quantization by the quantized activation layer 120. This pattern (Conv-BatchNorm-Activate) is common in convolutional neural networks (CNNs), especially with ReLU activations. There may be other layers introducing additional per-channel or per-tensor scaling factors or other linear transforms.

FIG. 1 also illustrates the thresholds that are used to perform the quantized activation layer 120. That is, the batchnorm layer 115 can generate a floating-point number, which the quantized activation layer 120 then positions among the sorted thresholds. The number of thresholds can depend on the number of desired output bits of the quantized activation layer 120. In the examples below, it is assumed that the desired output (k) is four bits. As such, the number of thresholds differentiating all possible 2\hat{ }4 quantization ranges the input might fall into would be 2\hat{ }4−1=15 in this example. Thus, the quantized activation layer 120 takes any input from the batchnorm layer 115 and positions it (i.e., quantizes it) with respect to the set of these 15 thresholds determining the count of thresholds that order in a specified manner (smaller than/larger than/not smaller than/not larger than) with respect to the given input.

At this stage, the thresholds can be represented by a linear function T(n). The actual values of the thresholds will be determined by the training process for the NN, so the actual threshold values and functions shown in the following figures are given just for exemplary purposes and for facilitating the discussion.

The hardware can determine the thresholds in two ways. First, because at this point the quantization thresholds are linear, the hardware can include logic that can calculate the thresholds from the linear equation T(n)=0.1333*n+0.0666. Alternatively, instead of calculating the thresholds, the 15 thresholds could be stored in memory in the hardware as floating-point values. Using an equation to generate the quantization thresholds rather than storing these thresholds may be preferred. Producing k-bit quantized activations (e.g., the number of output bits from the activation layer 120) for a-bit inputs means ((2\hat{ }k)-1)*a*channels bits of storage is required. For instance, the thresholds for quantizing 8-bit activations from 24-bit inputs, typically coming from accumulators of convolutional or matrix-multiply layers, using 1024 channels would occupy 6,266,880 bits of storage. This is compounded when floating-point activations are used as shown in FIG. 1.

FIG. 2 illustrates reducing the multiple layers of scaling factors of FIG. 1 into a single one. That is, FIG. 2 differs from FIG. 1 in that the floating-point linear transforms have been collapsed into one linear transform layer 205. At this point, the inference computation can be implemented by explicitly performing floating-point or fixed-point (under certain restrictions) multiply-add operations on the result of the quantized convolution.

The quantized activation layer 120 in FIG. 2 remains the same as in FIG. 1 in that the linear quantization thresholds can be represented by the same equation T(n) as introduced in FIG. 1.

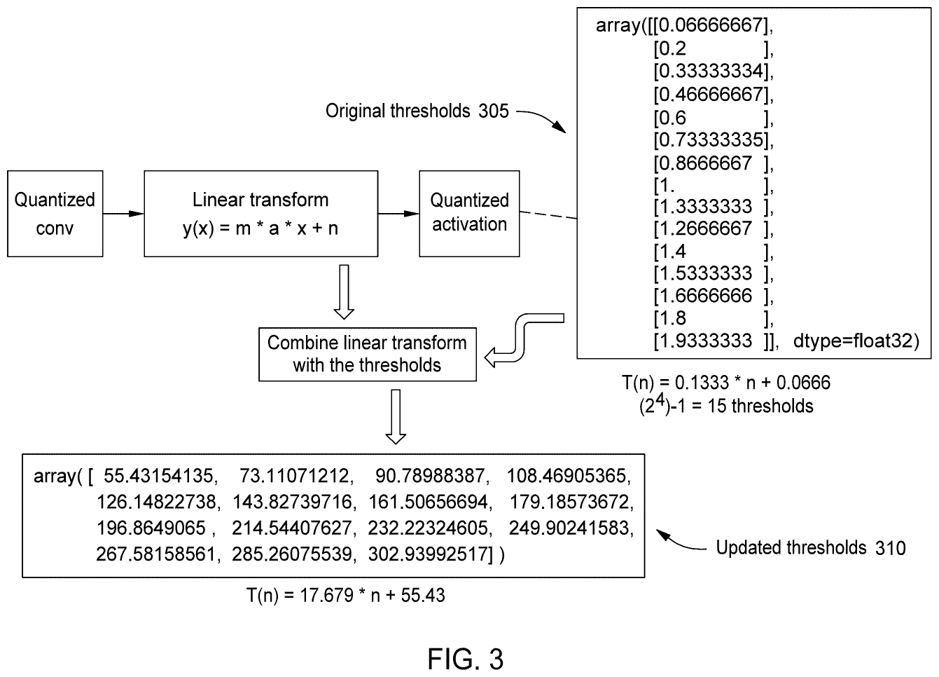

FIG. 3 illustrates that the calculations performed by the linear transform layer 205 in FIG. 2 can be absorbed into the thresholds used to perform quantization. That is, in FIG. 3, the quantization thresholds for the activation layer 120 are updated by absorbing the values of the floating-point multiple-add operations that were performed in the linear transform layer 205 in FIG. 2. Now, performing quantization at the layer 120 performs both the linear transform as well as quantization. This is based on the observation that having a stair step threshold comparison with a linear function that scales and adds to the input of the quantization activation, the linear transform can be removed entirely by updating the value of the thresholds.

FIG. 3 illustrates that the parameters of the linear transform are used to change the original thresholds 305 (that were also shown in FIGS. 1 and 2) to generate the updated thresholds 310. Nonetheless, the updated quantization thresholds 310 are still linear but are expressed using a different linear equation: T(n)=17.679*n+55.43.

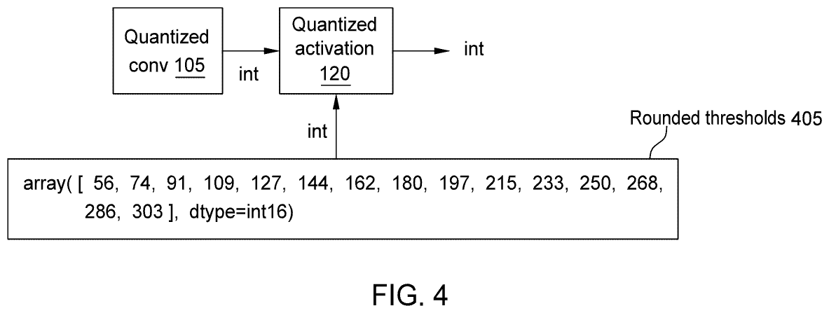

However, the original thresholds 305 and the updated thresholds 310 are expressed in floating-point values. These values can be simplified further when the inputs are integers. Assuming less-than-or-equal comparisons for positioning an input with respect to the thresholds, the thresholds can be rounded up to the nearest integer without affecting any of these ordering relationships. Under a strict less-than order, all thresholds can conversely be rounded down to the nearest integer without affecting the produced results. This is shown in FIG. 4. In one embodiment, this is a mathematically equivalent operation and introduces no accuracy degradation relative to the quantization activation in FIGS. 1-3. Unlike their original floating-point counterparts though, the rounded thresholds 405 are no longer an arithmetic sequence with a strictly uniform step size. This is due to the non-linear nature of the rounding operation. Put differently, the thresholds shown in FIG. 4 are now non-linear quantization thresholds and cannot be expressed using a linear equation.

Generally, because the rounded thresholds 405 are non-linear, this would mean they have to be stored in memory rather than being calculated on the fly (or as needed) using a linear equation. However, rounding the thresholds to generate integers is advantageous since the input is also an integer and storing integers can use less memory space.

Moreover, the thresholds 405 shown in FIG. 4 can be described as “near-uniform” in that the difference/delta between the thresholds is essentially the same: e.g., either 18 or 17 in this case. While there are other solutions for calculating non-linear thresholds that are near-uniform on-the-fly (as may be the case of ReLU), other activations such as tanh and sigmoid have non-linear thresholds that are not near-uniform. For these solutions, calculating the thresholds on-the-fly may not be feasible, in which case they are instead saved in memory (e.g., RAM). In addition, as the output of k bits grows, it may also not be feasible to calculate near-uniform thresholds of a ReLU activation function on-the-fly. The embodiments herein describe efficient techniques for comparing inputs to thresholds stored in memory, regardless of the desired output size and regardless whether the thresholds are linear/non-linear or near-uniform/not uniform.

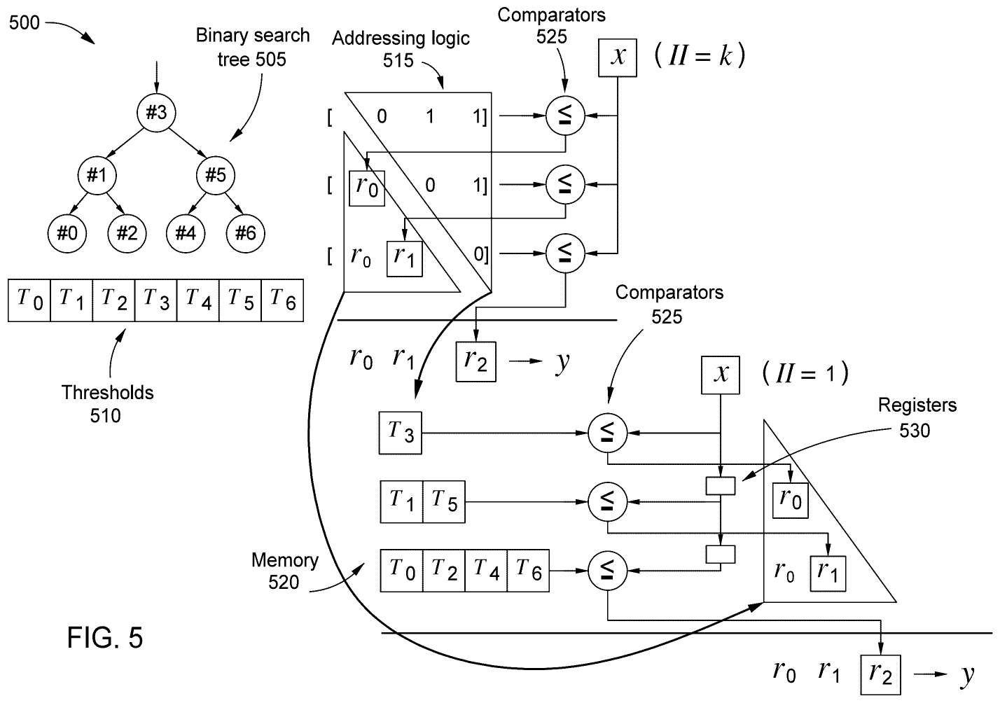

FIG. 5 illustrates quantization logic 500 implemented by traversing a binary search tree 505, according to one embodiment herein. The nodes in the binary search tree 505 represent different thresholds 510 (T0-T6). The root node (i.e., the top node) of the tree 505 represents the median or middle threshold T3. The two nodes in the next level of the tree 505 represent T1 and T5 and the last level of the tree 505 has leaf nodes that represent T0, T2, T4, and T6.

In operation, the input from the previous layer (e.g., the output of the quantized convolution layer 105 in FIG. 4) is compared to the threshold T3 corresponding to the root node. This does not change in that every input starts by being compared to the same root node (although the values of the thresholds may change for different feature maps, tensors, channels, etc.).

If the input is less than T3, the logic 500 next fetches the value of T1 from memory and compares it to the input. If the input is greater than T3, the logic 500 instead fetches the value of T5 from memory and compares it to the input.

The quantization logic 500 then identifies the threshold in the last level of the binary tree 505 to compare to the input. For example, if the input is less than T3 but greater than T1, the quantization logic 500 would then retrieve T2 from memory and compare it to the threshold. Depending on this output, the quantization logic 500 can indicate to the next layer in the NN the result of the quantization. Put differently, the input can be positioned among the thresholds and the encoded positional index then processed in the next layer.

Notably, the thresholds 510 are sorted in order from least to greatest. They are also mapped to sequential memory addresses in this order. This enables addressing logic 515 to easily select the next threshold for the next level of the binary tree traversal using the results from the previous comparison as shown by the addressing logic 515.

The addressing logic 515 illustrates receiving an input (x) which is compared to thresholds stored at the addresses on the left. In this example, the binary addresses correspond to the order of the thresholds. For example, the threshold T0 is stored at binary address 000, the threshold T1 is stored at binary address 001, the threshold T2 is stored at binary address 010, and so forth.

Because the input x is initially always compared to the median or middle threshold, no addressed lookup is needed as the addressing logic 515 is configured to always compare the input to T3 which is mapped to the binary address 011. The first comparator of the comparators 525 compares the input to the value of T3 to generate a resulting bit r0. This output of the comparator is already the most significant bit (MSB) of the ultimate result. It is also used to address and select the relevant threshold to compare to the input in the next stage of the binary search tree traversal. Notably, the other lower-order bits of the global address mapping are set for each individual stage and do not change. They serve as a unique identification of a specific stage within the global address space and enable the memory-mapped re-configuration or readback of thresholding parameters if this functionality is desired. That is, the least significant bits (LSBs) “01” of the address do not have to be computed by the addressing logic 515 and the local addressing solely depends on the output of the first comparator (i.e., r0).

For example, if the input x is less than T3, then r0=0 and the address for the next threshold is 0(01), which stores the value of T1. If the input x is greater than T3, then r0=1 and the address for the next threshold is 1(01) which stores the value of T5. In this manner, the results of the comparisons performed in the previous levels of the binary tree 505 generate the high-order bits for the address to select the correct threshold in the next level of the binary tree 505.

The second comparator of the comparators 525 compares the next threshold to the input x to generate a resulting bit r1. This output of the comparator is then used as the second MSB to address the next threshold to compare to the input. Moreover, the result r0 of the first comparison is still used as the MSB for the new address. In this case, the LSB of the address “0 ” is set and does not change. In this case, the address depends on both r0 and r1. Moreover, the address will correspond to one of T0, T2, T4, or T6. The next threshold is then compared to the input using the third comparator of the comparators 525 to generate a resulting bit r2.

The resulting bits r0, r1, and r2 can be interpreted as an index (y) to position the input with respect to the quantization thresholds. In this example, the smallest quantization threshold larger than the input is identified. If no threshold happens to be larger than an input, the produced index lies one beyond the highest threshold, which would be 7 in this example. The produced index y can be passed to the next layer as the quantized representation of the input.

The right side of FIG. 5 illustrates the same process as the addressing logic 515 but illustrates the local per-stage organization of memories 520 which store the thresholds, rather than the global address mapping. That is, for the first (or root) level, T3 is compared to the input x using the first comparator of the comparators 525. For the second level of the binary search tree, the result r0 from the first level is used to address (or select) either T1 or T5. For the third level of the binary search tree, the result r0 from the first level and r1 from the second level are used to address (or select) one of T0, T2, T4, or T6. Again, the results of the three levels are used to generate an index y that represents the quantization of input x as a positioning among the quantization thresholds.

Moreover, the right side of FIG. 5 illustrates registers 530 that can be used to pipeline the quantization logic 500. In this example, registers 530 are disposed between each level. As such, at the same time the latest input is being compared to T3 in the first level, its preceding input stored in the first register of the registers 530 can be compared to either T1 or T5 in the second level, and its second predecessor stored in the second register of the registers 530 can be compared to one of T0, T2, T4, or T6 in the third level. Thus, three different thresholding comparisons of inputs from the previous layer are performed independently and in parallel at the three levels of the binary search tree 505 at the same time. This pipelined embodiment avoids long signal paths with multiple comparisons and memory lookups chained combinationally. Pipelines deeper than the height of the binary search tree may be beneficial to further mitigate combinational latencies of comparators or memory lookups.

Each pipeline stage represents one complete level of the underlying search tree. Starting at the root of the tree, the first stage performs a comparison against the unique root element value determining the side (left or right) of the tree, in which the search is to continue logically. The comparison yields the first, most significant bit of the ultimate result. It is passed along to the next stage together with the original input key. The subsequent stages use the already computed output bits to look up the array element value for their concrete comparison within a local memory. This memory is the exclusive storage for all array values associated with the represented level of the search tree. The already computed result bits passed to the stage prescribe the search path taken so far and can serve as a direct index into the local memory as illustrated in FIG. 5.

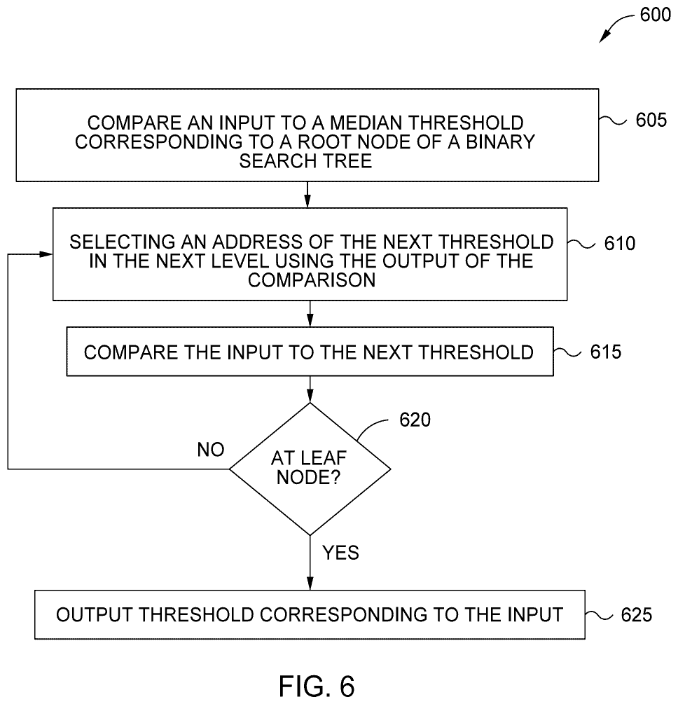

FIG. 6 is a flowchart of a method 600 for performing multi-thresholding using a binary search tree, according to an example. At block 605, a comparator in quantization logic compares an input to the median threshold at a root node of a binary search tree. Referring again to FIG. 5, the input is first compared to T3 in the root node of the binary search tree 505. While FIG. 5 illustrates a 3-level binary search tree 505, the method 600 can apply to a binary search tree of any number of levels, so long as the thresholds are sorted when stored in memory (e.g., smallest to largest).

At block 610, the quantization logic selects the address of the next threshold in the next level of the binary search tree using the output of the comparison performed at block 605. That is, the output of the comparator forms part of the address used to select the next threshold. In one embodiment, the output of the comparator serves as the MSB of the address of the next threshold that should be selected.

At block 615, a comparator in the quantization logic compares the input to the next threshold that was identified at block 610. If the quantization logic is at a leaf node (e.g., a bottom level of the binary search tree), the method 600 proceeds to block 625 where the quantization logic outputs the position of the input with respect to the thresholds in the form of an index. The index can be an index of a quantization threshold that corresponds to a closest bound of the input among the thresholds of the binary search tree so as to position the input among the thresholds with respect to a chosen strict or non-strict ordering relation. In one embodiment, the outputs of the comparators determined at blocks 605 and 615 are used to generate this address or index among the threshold, which is then passed to the next layer in a NN. In this manner, an input can be quantized with respect to different thresholds derived from an activation function.

However, if the threshold is not part of a leaf node, the method 600 returns to block 610 to select the address of the next threshold in the next level. In this manner, blocks 610-620 can repeat where the quantization logic compares the input to one threshold in each of the levels of the binary search tree until reaching a leaf node.

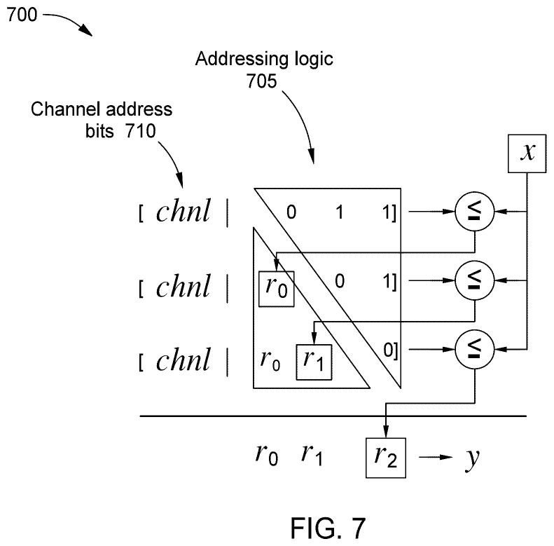

FIG. 7 illustrates per-channel quantization implemented using a binary search tree, according to an example. Specifically, FIG. 7 illustrates addressing logic 705 that supports per-channel quantization thresholds. The addressing logic 705 is the same as the addressing logic 515 in FIG. 5 except that the addressing logic 705 also receives channel address bit(s) 710. The channel address bits 710 serve as the MSBs for the address used to select the thresholds that are compared to the input x.

For example, rather than having thresholds T0-T6 for an entire tensor or feature map, the memory can store thresholds T0-T6 for each channel of the tensor or feature map (or whatever granularity is desired). The channel address bits 710 divide up or segment the thresholds. Thus, in addition to receiving the input x, the quantization logic can receive the channel address bits 710. The addressing logic 705 can then function the same as the address logic 515 in FIG. 5 where the results of the comparators are used to determine the next address for the next threshold. However, in this case, the resulting bits r0 and r1 are not the MSBs since those are the channel address bits 710.

As an example of per-channel thresholds, a feature map may include three channels for red, green, and blue pixels. The feature map may want to use a different activation function with different thresholds for the different channels. The channel address bits 710 can be used to store the red, green, and blue thresholds in different segments of memory. When a received input x is for, e.g., a red pixel, the addressing logic 705 can use the channel address bits 710 corresponding to the red channel as the MSB(s) in order to access the thresholds for the red channel. When an input for the green or blue channel is received, the channel address bits 710 can be changed to the bits for those channels while the rest of the addressing scheme remains the same.

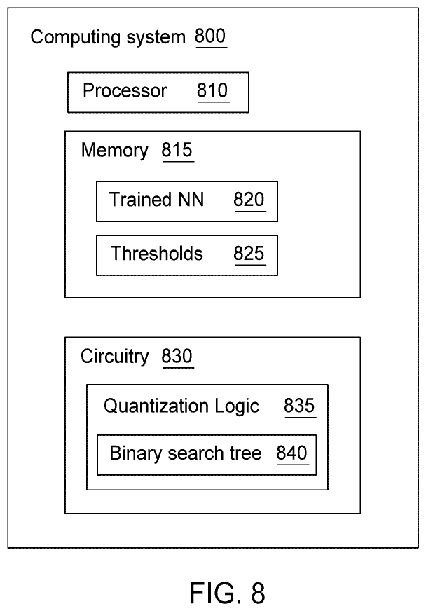

FIG. 8 is a block diagram of a computing system 800, according to an example. The computing system 800 includes a processor 805 and memory 815. The computing system 800 can be implemented as a single computing device (e.g., a server) or a system of multiple computing devices (e.g., interconnected servers or cards).

The processor 810 can represent any different type of processing element such as a central processing unit (CPU), a graphics processing unit (GPU), an application-specific integrated circuit (ASIC), and the like. The processor 810 can represent any number of processors (either the same type of processor or different types of processors) where each processor has any number of processing cores.

The memory 815 can include volatile memory elements, non-volatile memory elements, and combinations thereof. The memory 815 stores a trained NN 820. In one embodiment, the trained NN 820 includes thresholds 825 such as the quantization thresholds described above that may be part of an activation function (e.g., ReLU, tanh, sigmoid, etc.).

The computing system 800 also includes circuitry 830 that implements quantization logic 860 (which could be the quantization logic 500 in FIG. 5 or can include the addressing logic 705 in FIG. 7). While the circuitry 830 is shown as being separate from the processor 810, in some embodiments the circuitry 830 may be part of the processor 810.

The circuitry of the quantization circuitry 830 implements the traversal of a binary search tree 840, such as the binary search tree 505 in FIG. 5. When receiving an input, the quantization logic 835 can use the binary search tree 840 to search the thresholds 825 stored in memory 815 to assign a corresponding threshold.

The embodiments above are able to facilitate the efficient implementation of the multi-threshold operation. This operation is often used for the implementation of the quantization and re-quantization of activations in quantized neural network inference solutions where it typically also absorbs surrounding linear operators and monotonic activation functions as discussed in FIGS. 1-3. Ultimately, the multi-threshold operation locates the theoretical ordered position of a given input value within a sorted array of configured thresholds. The number of thresholds depends exponentially on the bit width (k) of the output quantization. Using (logarithmic) binary search rather than (linear) unrolled parallel comparisons greatly mitigates the induced compute pressure.

Moreover, the embodiments above are able to implement the multi-threshold operation with an initiation interval of 1 while avoiding the exponential explosion in space by using parallel comparators. This makes the adoption of wider bit width quantizations for latency-constrained, high-throughput quantized neural network inference solutions more economically feasible.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A computing system comprising:
circuitry comprising quantization logic implementing a binary search tree traversal, the quantization logic configured to:
compare an input to a median threshold corresponding to a root node of the binary search tree;
select, using an output of the comparison, an address of a second threshold in a second level of the binary search tree;
compare the input to the second threshold; and
select, using outputs of both comparisons, an address of a third threshold in a third level of the binary search tree.

2. The computing system of claim 1, wherein the quantization logic is configured to:
after reaching a leaf node of the binary search tree, return an index of a quantization threshold that corresponds to the closest bound of the input among the thresholds of the binary search tree so as to position the input among the thresholds with respect to a chosen strict or non-strict ordering relation.

3. The computing system of claim 1, wherein each node of the binary search tree corresponds to a different threshold of a plurality of thresholds.

4. The computing system of claim 3, wherein the plurality of thresholds are sorted in order from least to greatest and mapped to sequential memory addresses based on the order.

5. The computing system of claim 1, wherein comparing the input to the median threshold is performed using a first comparator and comparing the input to the second threshold is performed using a second comparator.

6. The computing system of claim 5, wherein the binary search tree is pipelined so that the first comparator can perform a comparison using a first input while the second comparator can perform a comparison using a second input.

7. The computing system of claim 1, wherein the quantization logic is part of an activation layer of a neural network.

8. The computing system of claim 1, wherein selecting, using the output of the comparison, the address of the second threshold in the second level of the binary search tree further comprises:
using the output of the comparison as a first bit of the address of the second threshold, wherein the other bits of the address of the second threshold are set and do not change.

9. The computing system of claim 8, wherein the median threshold, the second threshold, and the third threshold are per-channel quantization thresholds, wherein addresses of the median threshold, the second thresholds, and further thresholds contain a same channel address prefix as most significant bits (MSB).

10. The computing system of claim 1, wherein the quantization logic is configured to:
select, using the outputs of all preceding comparisons, threshold values in all further levels of the binary search tree.

11. A method, comprising:
comparing an input to a median threshold corresponding to a root node of a binary search tree;
selecting, using an output of the comparison, an address of a second threshold in a second level of the binary search tree;
comparing the input to the second threshold; and
performing quantization of the input based on outputs of both comparisons.

12. The method of claim 11, where performing quantization comprises:
after reaching a leaf node of the binary search tree, returning an index of a quantization threshold that corresponds to a closest bound with respect to the input, wherein the index of the quantized threshold comprises the outputs of all comparisons of a traversal of the binary search tree.

13. The method of claim 11, wherein each node of the binary search tree corresponds to a different threshold of a plurality of thresholds, wherein the plurality of thresholds are sorted in order from least to greatest and mapped to sequential memory addresses based on the order.

14. The method of claim 11, wherein comparing the input to the median threshold is performed using a first comparator and comparing the input to the second threshold is performed using a second comparator.

15. The method of claim 11, wherein selecting, using the output of the comparison, the address of the second threshold in the second level of the binary search tree further comprises:
using the output of the comparison as a first bit of the address of the second threshold, wherein the other bits of the address of the second threshold are set and do not change.

16. The method of claim 15, wherein the median threshold and the second threshold are per-channel quantization thresholds, wherein addresses of the median threshold and the second threshold contain same-channel address bits as most significant bits (MSB).

17. A binary search tree, comprising:
a first comparator configured to compare an input to a median threshold corresponding to a root node of the binary search tree;
circuitry configured to select, using an output of the first comparator, an address of a second threshold in a second level of the binary search tree;
a second comparator configured to compare the input to the second threshold; and
circuitry configured to select, using outputs of both the first and second comparators, an address of a third threshold in a third level of the binary search tree.

18. The binary search tree of claim 17, wherein each node of the binary search tree corresponds to a different threshold of a plurality of thresholds, wherein the plurality of thresholds are sorted in order from least to greatest and mapped to sequential memory address based on the order.

19. The binary search tree of claim 18, wherein the binary search tree is pipelined so that the first comparator can perform a comparison using a first input while the second comparator can perform a comparison using a second input.

20. The binary search tree of claim 17, wherein selecting, using the output of the first comparator, the address of the second threshold in the second level of the binary search tree further comprises:
using the output of the first comparator as a first bit of the address of the second threshold, wherein the other bits of the address of the second threshold are set and do not change.
